(19) United States
(12) Patent Application Publication
(10) Pub. No.: US 2010/0138292 A1
(43) Pub. Date: Jun. 3, 2010

(54) METHOD FOR PROVIDING AND SEARCHING INFORMATION KEYWORD AND INFORMATION CONTENTS RELATED TO CONTENTS AND SYSTEM THEREOF

(76) Inventors: Geun-Seop Park, Guri-si (KR); In Chul Kang, Seongnam-si (KR)

Correspondence Address: LEXYOUME IP GROUP, LLC, 5180 PARKSTONE DRIVE, SUITE 175, CHANTILLY, VA, 20151, US

(21) Appl. No.: 12/452,331

(22) PCT Filed: Jun. 25, 2008
(86) PCT No.: PCT/KR2008/003656

§ 371 Date: Dec. 24, 2009

(30) Foreign Application Priority Data
Jun. 26, 2007 (KR) 10-2007-0062997
Sep. 5, 2007 (KR) 10-2007-0089742
Jun. 17, 2008 (KR) 10-2008-0056877

(51) Int. Cl. G06Q 30/00; G06F 17/30

(52) U.S. Cl. 705/14.46; 707/769; 707/723; 705/14.54; 707/E17.014

(57) ABSTRACT

Provided is a method of providing and searching information keyword/information content related to content, and a system thereof. The present invention provides content to a user terminal accessing via a network and also provides an information keyword associated with the complete content or a portion of the content. Also, when the information keyword is selected, the present invention provides information content associated with the information keyword, and particularly, provides advertisement content among the information content. Through this, it is possible to further improve the information providing effect and the advertising effect. The information keyword and the information content may be directly set, added, corrected, and deleted by a plurality of users. It is also possible to enable a user to easily identify an information keyword and content by displaying a portion corresponding to the information keyword to be discerned from a portion that does not correspond to the information keyword in corresponding content.

### TECHNICAL FIELD

The present invention relates to a method of providing and searching an information keyword/information content, and a system thereof. More particularly, the present invention relates to a method of providing or searching an information keyword associated with the complete content or a portion of the content and information content related to the information keyword, and a system thereof.

### BACKGROUND ART

Currently, with advancements in network technology, various types of global information can be shared. Various types of information, for example text, images, moving images, audio (including voice, music, sound sources, etc.) that are generally provided via a network are referred to as “content(s)”. Particularly, as information and communication systems such as the Internet, digital cameras, mobile phones, and the like are being quickly developed, general users, although they are not experts, can create more meaningful information faster than existing media. The information is referred to as user created content (UCC) or user generated content (UGC). The UCC or UGC is being developed from an early stage of entertainment based on text and pictures that were simply viewed for enjoyment to a state of professional amateur created contents (PCC) that are created by an expert level of professional amateurs, through information providing contents based on moving images.

Diversified contents including UCC are being manufactured by information and communication users of various fields based on their efforts and time, whereas revenues using the contents were barely made. For example, UCC using images does not provide a particular revenue model or advertisement. Also, UCC using video contents provides advertisements at the level of inserting an advertisement in front or/and at the back of the video content.

However, in the above advertisement scheme, although a user does not desire to, the user may need to view the advertisement. Thus, the user may feel averse to the advertisement. Also, when the advertisement is less related to the corresponding UCC, the advertising effect may be deteriorated. In addition, when the user views only the UCC by omitting the advertisement provided in front or/and at the back of the UCC, the advertising effect may also be decreased.

Also, a currently widely used advertisement scheme includes a banner advertisement providing a user with advertisement content using an image, a moving image, and the like, and a keyword advertisement of outputting an advertisement connected to a particular word when the user inputs the particular word.

However, the current banner advertisement displays the same content for not only a user needing the advertisement but also for nonspecific users. Thus, the advertising effect may be significantly decreased. Further, the keyword advertisement displays a list of products or services consistent with a particular word input by the user input, and an advertiser needs to pay a large amount of advertisement cost in order to secure keywords. Also, when the user is unaware of a product or service name, the keyword advertisement may not output accurate advertisement content.

There is another disadvantage in that many content users may not readily obtain information related to a corresponding content. For example, when moving image content is played in association with a particular subject, a user may need information associated with a particular place or product being displayed in the content. In this case, in order to obtain the information, the user may need to undertake troublesome procedures of moving to a website providing related information and accessing the website. Also, when the user is unaware of the accurate name of the particular place or product being displayed in the corresponding content, it may be difficult for the user to obtain the related information despite efforts.

Accordingly, there is a need for a method of producing revenue using various types of contents being provided via a network and for a method of effectively providing information related to the contents.

### DETAILED DESCRIPTION

### Technical Object

An exemplary embodiment of the present invention provides a method of providing and searching an information keyword and information content related thereto that can effectively provide information associated with contents being provided via various types of wired/wireless networks.

Another embodiment of the present invention also provides a method of efficiently providing advertisements associated with contents being provided via various types of wired/wireless networks.

### Technical Solution

According to an embodiment of the present invention, there is provided a method of providing, by a system, an information keyword related to content via a network, the method including: receiving, by the system, an information keyword request from a user terminal that receives the content; identifying, by the system, a portion corresponding to the information keyword request from the content; and providing, by the system, the user terminal with an information keyword corresponding to the identified portion.

In this instance, the method may further include: receiving, by the system, an information content request from the user terminal that receives the information keyword; and providing the user terminal with information content corresponding to the information keyword.

Also, the providing of the information keyword may include displaying the portion corresponding to the information keyword to be discerned from a portion that does not correspond to the information keyword.

According to another embodiment of the present invention, there is provided a method of searching, by a system, an information keyword when the system provides an information keyword related to content via a network, the method including: receiving, by the system, a search word from a user terminal; searching, by the system, information keywords corresponding to the search word; searching, by the system, portions corresponding to the searched information keywords from predetermined content; extracting, by the system from the content, constituent portions of the content that include the searched portions; and providing, by the system, the user terminal with the search results including the extracted constituent portions.

According to still another embodiment of the present invention, there is provided a system for providing a user terminal with an information keyword related to content via a network, the system including: a keyword management server to set and manage an information keyword that is output in association with content; and an output processing server including a content identification unit to identify a portion providing the information keyword from output content, a keyword allocation unit to allocate a corresponding information keyword to the identified portion, and a content output unit to add the allocated information keyword to the content and output the content.

### ADVANTAGEOUS EFFECT

According to exemplary embodiments of the present invention, it is possible to enable a plurality of users to set an information keyword and/or information content appropriate for complete contents or a portion of the contents being provided using an information communication service and to more effectively provide a user with the set information keyword and/or information content. Particularly, it is possible to more effectively provide a user with an information keyword and information content related to content, and detailed descriptions thereof by displaying portions corresponding to the information keyword to be discerned from other portions in the content. As a result, it is possible to further improve information transferability and thereby enhance an information providing effect and advertising effect.

Also, a user may correct, add, or delete a set information keyword or information content. The set information keyword or information content may be verified, whereby reliable information may be provided.

It is also possible to enable the user to more readily search information keywords related to particular content and to more effectively provide the user with the searched information keywords.

Also, while a user is using content, it is possible to connect the user with an advertiser that provides a product or service included in or related to the content, using an information keyword and information content corresponding thereto. Through this, it is possible to improve the advertising effect. As a result, an advertiser may provide services and products for actual end users instead of a nonspecific majority, thereby obtaining the enhanced advertising effect with limited costs.

In addition, the user may visually and audibly confirm a product or service included in or related to content, and then directly select the product or service and purchase or use the product or service. Accordingly, it is possible to conveniently and accurately search and purchase a product and service, and to obtain the accurate segmented advertising effect at the same time.

Further, it is possible to fairly and effectively distribute revenues obtained from an advertisement service to a user setting advertisement content, a content creator, and a content provider.

### BRIEF DESCRIPTION OF THE DRAWINGS

FIG. 1 is a block diagram illustrating a network connection state of an information keyword providing system according to an exemplary embodiment of the present invention.

FIG. 2 is a configuration diagram of an information keyword providing system according to an exemplary embodiment of the present invention.

FIG. 3 is a configuration diagram of an advertisement system connected to an information keyword providing system according to an exemplary embodiment of the present invention.

FIG. 4 is an embodiment example of an information keyword providing system according to an exemplary embodiment of the present invention.

FIG. 5 is a flowchart illustrating a process of setting an information keyword according to an exemplary embodiment of the present invention.

FIG. 6 is a flowchart illustrating a process of verifying an information keyword according to a first example of an exemplary embodiment of the present invention.

FIG. 7 is a flowchart illustrating a process of verifying an information keyword according to a second example of an exemplary embodiment of the present invention.

FIG. 8 is a flowchart illustrating a process of editing an information keyword according to an exemplary embodiment of the present invention.

FIG. 9 is a flowchart illustrating a process of processing an advertisement connection according to an exemplary embodiment of the present invention.

FIG. 10 is a flowchart illustrating a process of providing an information keyword according to an exemplary embodiment of the present invention.

FIG. 11 is a flowchart illustrating a usage example of content according to an exemplary embodiment of the present invention.

FIG. 12 is a flowchart illustrating another usage example of content according to an exemplary embodiment of the present invention.

FIG. 13 is a flowchart illustrating a query and answer process according to a first example of an exemplary embodiment of the present invention.

FIG. 14 is a flowchart illustrating a query and answer process according to a second example of an exemplary embodiment of the present invention.

FIG. 15 is a flowchart illustrating a process of converting an information keyword according to an exemplary embodiment of the present invention.

FIG. 16 is a flowchart illustrating a process of searching an information keyword according to an exemplary embodiment of the present invention.

FIG. 17 is a flowchart illustrating a process of searching an information keyword according to another exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements. In addition, the terms “-er”, “-or”, and “server” described in the specification mean units for processing at least one function and operation and can be implemented by hardware components or software components and combinations thereof.

The term “content/contents” used throughout the present specification includes all the things that can be provided in various types that can be visually or audibly verified by a user, for example, text, images, moving images, audio (including voice, music, sound sources, etc.,) and the like, or that can be provided as a multimedia type that is a combination of the various types.

Also, the term “information keyword” used throughout the present specification includes all the types of information that can be provided for the purpose of advertisement or information with respect to contents. The information keyword may be provided as a type of text, image, moving image, audio (including voice, music, sound sources, etc.), and the like, or may be provided as a multimedia type that is a combination of the types.

Also, the term “user” used throughout the present specification denotes a user that uses content via a communicable apparatus. Also, using content may include all the content-based behaviors such as viewing the content, purchasing the content, and the like.

Hereinafter, a method of providing an information keyword and information content related to content, and a system thereof according to an exemplary embodiment of the present invention, will be described with reference to the accompanying drawings.

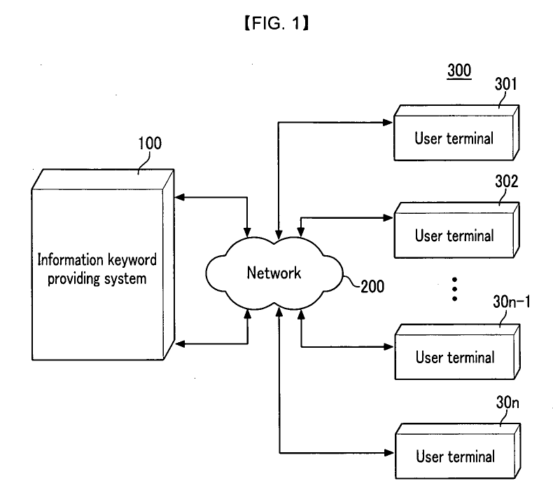

FIG. 1 is a block diagram illustrating a network connection state of systems for providing an information keyword and/or information content related to content according to an exemplary embodiment of the present invention.

As shown in FIG. 1, the system for providing the information keyword and/or information content related to the content (hereinafter, for better comprehension and ease of description, referred to as “information keyword providing system 100”) is connected to a plurality of user terminals 301, 302, . . . , 30n−1, 30n (hereinafter, for better comprehension and ease of description, these are assigned a representative reference numeral “300”) via a network 200. Here, the user terminal 300 being connected to the information keyword providing system 100 via the network 200 includes a connection state where the user terminal 300 directly connects with the information keyword providing system 100 via the network 200 to thereby receive a plurality of data such as contents, the information keyword, and the like, or a connection state where the user terminal 300 may receive data from the information keyword providing system 100 via at least one different system (not shown) in the network 200.

The user terminal 300 denotes any type of terminal that can perform communication via a wired/wireless communication network, a broadcasting network, or an exclusive network. Examples of the user terminal 300 include a personal computer (PC), a personal digital assistant (PDA), a mobile communication terminal, a card transaction terminal, a point of sale (POS) terminal, a set-top box enabling bi-directional communication using a television (TV), a cash dispenser (CD), an automatic teller machine (ATM), a GIRO teller machine, an apparatus with a monitor installed in a shopping center, etc., a kiosk, and the like. The user terminal 300 may denote all the computer apparatuses that include an external communication device, an input/output device, and a self-computational function.

The network 200 provides a wired/wireless communication path between the network 200 and the user terminal 300. The network 200 includes the general Internet that includes a global open computer network structure of providing a transmission control protocol/Internet protocol (TCP/IP) and various services existing in an upper layer thereof, that is, a hypertext transport protocol (HTTP), a telnet, a file transfer protocol (FTP), a domain name system (DNS), a simple mail transfer protocol (SMTP), a simple network time protocol (SNTP), a network file system (NFS), and a network information service (NIS). Also, the network 200 includes various types of wired/wireless communication scheme networks such as a high speed wireless data communication network, for example a wireless broadband Internet (Wibro), a high speed downlink packet access (HSDPA), etc., a broadcasting network (e.g., an analog broadcasting network, a digital broadcasting network, an Internet protocol television (IPTV) broadcasting network, a digital multimedia broadcasting (DMB) network, etc.), a telephone network, a mobile communication network, and the like.

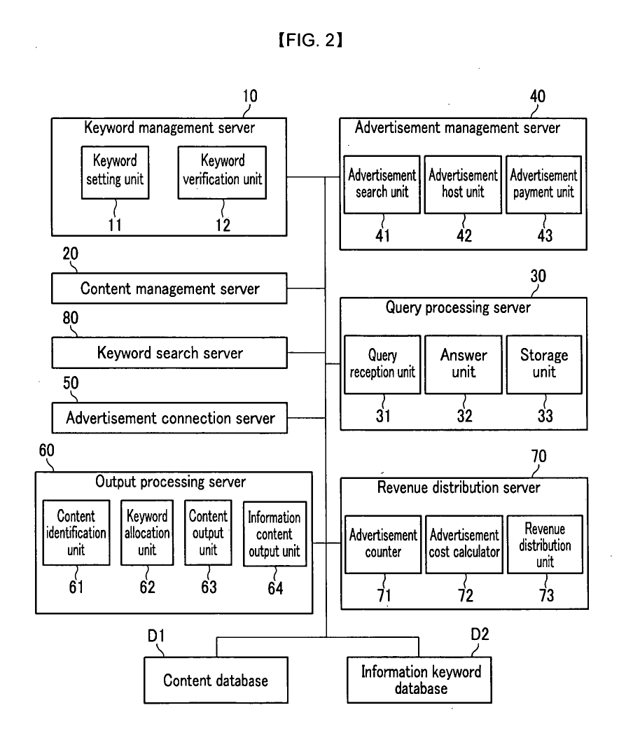

FIG. 2 is a configuration diagram of an information keyword providing system 100 according to an exemplary embodiment of the present invention.

As shown in FIG. 2, the information keyword providing system 100 according to an exemplary embodiment of the present invention includes a keyword management server 10, a content management server 20, a query processing server 30, an advertisement management server 40, an advertisement connection server 50, an output processing server 60, a revenue distribution server 70, and a keyword search server 80. In addition, the information keyword providing system 100 includes a content database D1 and an information keyword database D2.

The keyword management server 10 functions to set and manage an information keyword that is output in association with content according to an exemplary embodiment of the present invention. Specifically, the keyword management server 10 includes a keyword setting unit 11 to set information keywords that are provided in association with contents and a keyword verification unit 12 to perform verification for the information keywords.

The keyword setting unit 11 functions to set at least one information keyword related to content, and generate and manage a list of information keywords. Also, the keyword setting unit 11 functions to add, correct, or delete an information keyword as necessary. A process of adding, correcting, and deleting the information keyword will be described in detail later.

Also, the keyword setting unit 11 functions to generate and manage information associated with the generated information keyword. Every time the information keyword is generated, corrected, or deleted, the keyword setting unit 11 may update a list of information keywords stored in the information keyword database D2 in real time, or may update lists by periodically reflecting changed matters. According to an aspect of the present invention, users, content providers, content creators, or advertisers may directly input and set information keywords.

The keyword verification unit 12 functions to determine whether the generated information keywords are appropriate and to provide the result thereof to the keyword setting unit 11. Accordingly, the keyword setting unit 11 may select only keywords that are verified to be appropriate by the keyword verification unit 12, and set the selected keywords as information keywords related to corresponding content. When the information keyword is inappropriate for the corresponding content, when the information keyword has a problem of a copyright infringement, or when the information keyword includes provocativeness, violence, racism, and the like, the keyword verification unit 12 may inform the keyword setting unit 11 that the information keyword may not be set. In this case, as necessary, reasons according to setting inappropriateness may be reported to an entity setting the information keyword, an entity distributing the content, or an entity managing keywords.

The above keyword verification may be performed by comparing the information keyword with verification criterion information, and when the information keyword includes the verification criterion information, determining that the information keyword is inappropriate. The information keyword verification will be described in detail later.

The content management server 20 functions to store and manage contents combined with an information keyword or connection information associated with contents stored in a separate system or server. Specifically, the content management server 20 assigns a unique number to each of the contents and manages the contents with the assigned unique number. Also, when new content is added in interoperation with the content database D1, the content management server 20 updates a list of contents stored in the content database D1 in real time, or periodically updates the list. In addition, in preparation in which a user indicates or selects a portion of content, including mouse-over, or in preparation when it is necessary, the content management server 20 may additionally store related images and messages, and manage a list thereof. In this instance, the mouse-over denotes that a mouse cursor does not move or stays for a predetermined period of time with respect to each of contents. The additionally stored images and messages may be stored in the content database D1. Also, the content management server 20 may collect information associated with a content provider and a content creator, store the collected information, and manage a list thereof.

Also, when the information keyword providing system 100 provides an information keyword in interoperation with at least one affiliated system (e.g., a system for providing contents in a network such as a website), the content management server 20 may update a content list and connection information in association with the affiliated system in real time or periodically, and may store the result thereof. Particularly, when contents to be combined with an information keyword are stored and managed in the affiliated system, the content management server 20 may store and manage only content connection information associated with content stored in the affiliated system, instead of storing and managing the content. In this case, an information keyword to be combined with content provided by the affiliated system is provided based on the content connection information.

The query processing server 30 functions to process a query associated with content and provide an answer thereto. Specifically, the query processing server 30 includes a query reception unit 31 to inform terminals of a plurality of second users connected to a network or terminals of subsequently accessing third users of an event when a query for predetermined content is received from a first user, an answer unit 32 to transmit an answer to the first user terminal when the answer is received from the second user terminals or the third user terminals in response to the query, and a storage unit 33 to store the query and the answer thereto. The query and answer process will be further described in detail later.

The advertisement management server 40 functions to perform connection with an advertiser that desires to place an advertisement using content. Specifically, the advertisement management server 40 includes an advertisement search unit 41 to search a currently maintained list of information keywords and a list of contents related thereto according to request of the advertiser, and an advertisement host unit 42 to compare information keywords with a product/service list of the advertiser and when a mapping keyword is included in the product/service list, inform the advertiser of the event.

When a request for connecting advertisement content to a predetermined information keyword and/or content is received from the advertiser, the advertisement host unit 42 stores and manages advertisement output information associated with the advertisement content to be connected to the information keyword and/or content. In this instance, it is possible to store and manage advertisement placement conditions such as costs, period, exclusiveness, and the like in association with the advertisement output. In this instance, the advertisement content denotes content that is designed for an advertisement provided by an advertiser among information contents. The advertisement content includes various types of identifiable contents (e.g., a moving image, audio, an image, etc.) such as an advertisement message and the like.

In addition, the advertisement management server 40 may further include an advertisement payment unit 43 to perform payment for a connection between a corresponding information keyword and/or content and advertisement content, according to request of the advertiser. In this case, the advertisement search unit 41 may transfer, to the advertisement connection server 50, only output advertisement information and advertisement placement conditions associated with the paid advertisement content connection processing request.

According to the request of the advertiser, the advertisement connection server 50 may connect advertisement content with a predetermined information keyword and/or content so that the corresponding advertisement content may be provided together with the content. Particularly, the advertisement connection server 50 may output advertisement content that is connected to the predetermined information keyword and/or content based on advertisement output information and/or advertisement output condition information that is transferred from the advertisement management server 40.

Also, when predetermined advertisement content is output, the advertisement connection server 50 transmits the result thereof to the revenue distribution server 70 so that advertisement revenues may be distributed to parties concerned with the advertisement revenues. Here, the concerned parties may include those who have contributed to the revenues or made a contract to receive the revenues, for example an advertiser, an operator of an information keyword providing system, and an operator of a content providing system. Also, the concerned parties may include an information keyword provider, a content provider, a content copyright holder, and the like.

The output processing server 60 provides a related information keyword together when providing content according to an exemplary embodiment of the present invention. Also, the output processing server 60 additionally provides information content related to the information keyword. Specifically, the output processing server 60 includes a content identification unit 61 to identify a portion of providing an information keyword from output content, a keyword allocation unit 62 to allocate a corresponding information keyword to the identified portion, and a content output unit 63 to add the allocated information keyword to the output content and output the content. Also, the output processing server further includes an information content output unit 64 to output information content related to the information keyword.

The content identification unit 61 searches the portion providing the information keyword from additional information (tag) associated with information keywords corresponding to a unique number of the output content. Also, the content identification unit 61 searches a serial number of the portion from location information associated with the portion of the content that matches the information keyword in the additional information, that is, the searched portion, and provides the searched serial number to the keyword allocation unit 62.

The keyword allocation unit 62 searches information keywords based on serial numbers of a portion providing a corresponding keyword and provides additional information associated with the searched information keywords to the content output unit 63.

The content output unit 63 outputs content and also outputs a corresponding information keyword in a portion corresponding to a serial number obtained from the content identification unit 61, based on the additional information.

Also, the information content output unit 64 outputs information content or advertisement content corresponding to an information keyword in interoperation with the advertisement connection server 50. Particularly, the information content output unit 64 determines an output location and an output type of information content and advertisement content, and outputs the information content or advertisement content based on the determined location and type. Accordingly, while viewing content, a user may receive an information keyword related to the complete content or a portion of the content. Also, the user may receive information content or advertisement content associated with the information keyword.

According to an aspect of the present invention, an information keyword may be displayed adjacent to an upper/lower portion or a left/right portion based on a predetermined portion of content. Also, the information keyword may be displayed using a separate information keyword output space. Information content and advertisement content may be displayed adjacent to an upper/lower portion or a left/right portion of a content display region. Also, the information content and advertisement content may be displayed using a separate information content or advertisement content output space. However, a location for outputting the information keyword and information content according to the present invention is not limited thereto.

According to an aspect of the present invention, while outputting content, an information keyword and/or information content related to the content may be automatically included in the content and thereby be output. Also, according to a user request, the information keyword and/or information content may be selectively included in the content and thereby be output. For example, when a portion associated with an information keyword is played regardless of the user request while playing the content, the information keyword may be automatically output. Also, regardless of the user request, the information content related to the information keyword may be output. However, unlike this, when a behavior in which a user selects a portion of the content is detected while playing the content (e.g., a behavior in which the user locates a mouse cursor on a predetermined portion of the content, etc.), an information keyword corresponding to the portion may be output. In this case, when a behavior for automatically outputting information content related to an information keyword, or when a behavior in which a user requests the information content (e.g., a behavior that the user clicks a separate button or clicks a right button of a mouse, etc.) is detected, the related information content may be output.

As described above, when outputting the content, a process of adjusting resolution, size, color, play speed, and the like of the content may be performed to more explicitly discern the information keyword and/or information content. The above process will be described in detail later.

The revenue distribution server 70 distributes revenues that are generated according to an advertisement content output in association with an information keyword. Specifically, the revenue distribution server 70 includes an advertisement counter 71 to count the number of outputs of advertisement content that is displayed for users, an output amount, and the like, an advertisement cost calculator 72 to calculate an advertisement cost based on the counted number of outputs of the advertisement content, the output amount, and the like, and a revenue distribution unit 73 to determine a revenue distribution rate with respect to an information keyword setter, a content creator, a content provider, and a keyword manager managing the information keyword in association with the information keyword and distribute the calculated advertisement cost according to the determined distribution rate.

The advertisement cost calculator 72 requests a corresponding advertiser to pay the calculated advertisement cost. Also, the advertisement cost calculator 72 functions to collect results in association with the advertisement output results collected in an advertisement system which will be described, compare the results with self-collected results by the revenue distribution server 70, and correct the results.

The keyword search server 80 functions to search a query, an answer, and the like with respect to an information keyword and content related to specific content, and provide the search result thereof. In this case, the keyword search server 80 may output a query and an answer to the user terminal 300 together with the related content. A search process using the keyword search server 80 will be further described in detail later.

The information keyword providing system 100 constructed as above may include the content database D1 and the information keyword database D2.

The content database D1 functions to manage and store content to be output for a user. Also, the content database D1 may manage and store connection information associated with content that is stored and managed in another database excluding the content database D1. In order to output an information keyword set in a predetermined portion of content, the content database D1 manages and stores the original content copy together with the portion that is set with the information keyword. Specifically, a unique number is assigned to the entire single content. A serial number extracted from the assigned unique number is assigned to portions set with the information keyword. For example, when content is in an image type containing a World Cup support picture, the unique number “wc1000” is assigned to the content. Serial numbers “wc1000-001, wc1000-002, wc1000-003, wc1000-004, etc.”, are assigned to objects included in the content, for example, clothes, shoes, a building, a person, and the like.

In this instance, portions inserted into the content may be created using a file type of an original content, a flash animation, an animation-gif, and the like. Accordingly, when the user uses the content, the mouse-over where a mouse cursor does not move or stays in each portion for more than a predetermined period of time may frequently occur. As necessary, when a behavior in which the user indicates or selects a portion of content, including the mouse-over, is detected, it is possible to output, to the user, an information keyword, or other content or message associated with a query and answer related to the content that is made by second users.

The information keyword database D2 functions to store at least one information keyword corresponding to the complete content or a portion thereof stored in the content database. Each of information keywords includes a keyword identification (ID) number. When the corresponding information keyword is set, a keyword ID number may be assigned to the information keyword. Information associated with a keyword creator that created a corresponding information keyword may be stored in correspondence to the keyword ID number. The information may be used for later revenue distribution.

A unique number of content of a corresponding information keyword and an object serial number denoting where the information keyword is used in the content may be stored in correspondence to a keyword ID number of information keywords.

Particularly, according to an aspect of the present invention, information keywords include additional information associated with content, context information associated with the content, or metadata associated with the content.

The additional information denotes information that is directly/indirectly associated with combination between content and an information keyword. The additional information includes a start time point and an end time point of a play time of the corresponding information keyword with reference to a play time of related content, and location information in the content where the information keyword is combined. Here, the location information may denote location information associated with a portion of the content that is combined with the information keyword among the entire content, location information associated with a portion of the content corresponding to the information keyword, or information associated with a location where the information keyword needs to be output in a content display region. For example, when the content is a moving image, the location information denotes from which frame the information keyword is output, with which location of the frame the information keyword is combined, in which location of the frame the information keyword is output, and the like.

The context information associated with the content denotes information associated with a background and a situation of the content. The context information may include information associated with particulars constituting the content, information associated with a character and a background, and information associated with play time of each particular and other contents. For example, when the content is a movie, the context information may include the title of the movie, the award history of film festivals, the leading actor, the filming location, the movie director, staff, a film item, running time, a famous scene, a famous line, a film purpose, and the like.

The metadata associated with the content denotes information that is required for classifying, categorizing, using, and searching an information keyword and content, and information content. The metadata may include information regarding who, when, where, how, and why the information keyword and content was used, and the information content, multi-lingual information (e.g., subtitle information), information associated with a content creator, a copyright holder, a distributor, etc., whether content is paid or free, a field of the content and a field of the information content, the file format of the content and the information content or other related content, the number of times/ratio/play time that a particular information keyword appears over the entire play time of the content when the content is a moving image or audio, and the number of times/ratio that the particular information keyword occupies in the entire content when the content is an image or other file.

Also, the metadata may include connection information between the information keyword and the information content. Specifically, when a particular information keyword consecutively or non-consecutively appears a predetermined number of times in the content, it is possible to record the number of times by setting a unique number of the particular information keyword. Through this, it is possible to calculate and manage an appearance frequency, appearance time, etc. of the particular information keyword. Also, it is possible to set a unique number to a mutually related information keyword and information content and thereby trace a correlation therebetween. For example, when the content includes an information keyword “Madonna” and an information keyword that can be related thereto, for example, a handbag of Madonna and a dress of Madonna, it is possible to set unique numbers such as person001 (p001), object100 (0100), and wear200 (w200) to Madonna, the handbag, and the dress and thereby set unique numbers such as p001-o100 and p001-w200 to the handbag of Madonna and the dress of Madonna. Through this, it is possible to collectively manage the appearance frequency and the appearance time point (start time point, end time point, play time) of the information keyword.

The information keyword providing system 100 constructed as above may be connected to a plurality of advertisement systems being operated by an advertiser.

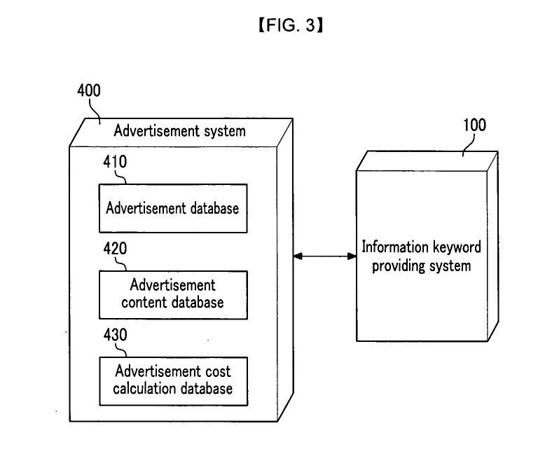

FIG. 3 is a block diagram illustrating a configuration of an advertisement system 400 according to an exemplary embodiment of the present invention.

The advertisement system 400 according to an exemplary embodiment of the present invention is a system that is operated and managed by an advertiser. As shown in FIG. 3, the advertisement system 400 includes an advertisement database 410, an advertisement content database 420, and an advertisement cost calculation database 430.

The advertisement database 410 functions to store lists of advertisement contents that are being executed in response to a request for the information keyword providing system 100 and advertisement information that includes an advertisement placement condition associated with each advertisement content. The advertisement information includes storage information of advertisement content that is stored in the advertisement content database 420, or location information of the advertisement content when the advertisement content is stored in a separate server excluding the advertisement content database 420. In addition, the advertisement information includes cost information according to advertisement placement.

The advertisement content database 420 functions to store advertisement content that is placed in association with an information keyword of content output via the information keyword providing system 100, and information thereof.

The advertisement cost calculation database 430 functions to store count information associated with advertisement content output such as a number of outputs for advertisement contents that are output in association with content, an output route, an output medium, and the like. The above information may be used to calculate the advertisement cost and distribute revenues via the revenue distribution server 70. Also, result information according to calculation of the advertisement cost and distribution of revenues may be additionally stored.

The advertisement system 400 requests placement of advertisement content for an information keyword of predetermined content in interoperation with the information keyword providing system 100, based on the above-described databases 410, 420, and 430. Also, the advertisement system 400 provides the information keyword providing system 100 with a product/service list to be advertised. Further, the advertisement system 400 receives, from the information keyword providing system 100, an information keyword list mapping the product/service list. As necessary, the advertisement system 400 requests placement of the information content related to the information keyword.

Also, according to an information content request from the information keyword providing system 100, it is possible to provide corresponding advertisement content stored in the advertisement content database 420 and output the advertisement content together with predetermined content.

The above-described constituent elements of the information keyword providing system 100 are classified according to function thereof. Depending on embodiments, the constituent elements may be differently classified. For example, the content database D1 and the information keyword database D2 may be constructed as a single server. Also, the content database D1 and the information keyword database D2 may be included in the content management sever 20 or the keyword management server 10.

In addition, the information keyword providing system 100 may be constructed to include the databases 410, 420, and 430 that are included in the advertisement system 400.

The information keyword providing system 100 constructed as above may provide content and an information keyword related thereto in interoperation with a content providing system that provides contents to user terminals via a network.

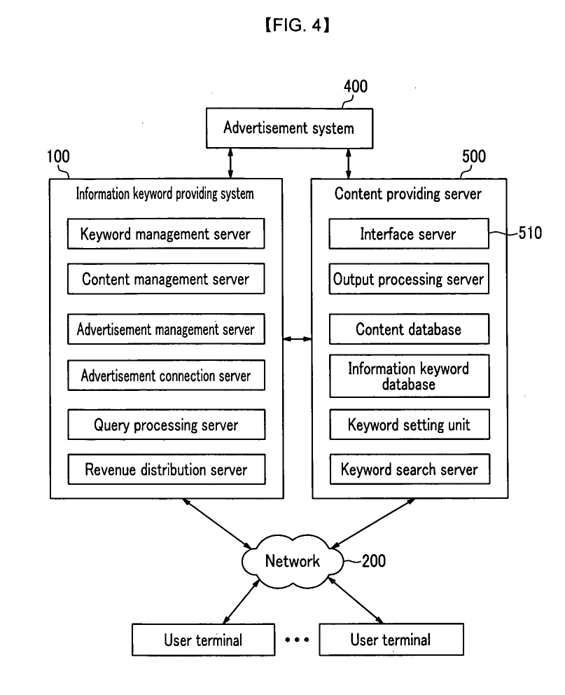

FIG. 4 is an embodiment example where an information keyword providing system 100 interoperates with a content providing system 500 in a network 200 according to an exemplary embodiment of the present invention. In this case, at least one of constituent elements may be constructed to be located in the content providing system 500.

The content providing system 500 according to an exemplary embodiment of the present invention denotes a system that is operated and managed by a content provider including providers of all the commercial/non-commercial websites and broadcasting contents that can provide information and output an advertisement via the network 200. For example, the content providing system 500 may be a system that provides a web service or WAP service, or may also be a system that provides a bi-directionally communicable broadcasting service.

The content providing system 500 may include an interface server 510 to provide content for user terminals 300 accessing via the network 200. Particularly, in interoperation with the information keyword providing system 100 according to an exemplary embodiment of the present invention, the content providing system 500 provides at least one information keyword in correspondence to the complete content or a portion of the content. In addition, as necessary, or when a user request is received, the content providing system 500 may provide information content related to an information keyword and, particularly, advertisement content among the information content.

The interface server 510 may be, for example, an Internet information server (IIS) developed by Microsoft corp., an Apache server developed by the National Center for Supercomputing Applications (NCSA) of the University of Illinois, etc. The interface server 510 may be a server providing a web service or a WAP service. In addition, the interface server 510 may be a device that functions to provide content and content-related information through communication with the user terminal 300.

As shown in FIG. 4, the content providing system 500 may be constructed to include at least one of an output processing server, a content database, an information keyword database, a keyword management server, and a keyword setting unit and a keyword search server of a keyword management server that are included in the information keyword providing system 100. In this case, the information keyword providing system 100 may be constructed to include all the constituent elements as shown in FIG. 2. Also, in this case, the output processing server, the content database, the information keyword database, and the keyword management server of the information keyword providing system 100 may perform the above-described functions in interoperation with the corresponding constituent elements that are embodied in the content providing system 500.

Also, as shown in FIG. 4, the information keyword providing system 100 may be constructed to include remaining constituent elements excluding constituent elements that are included in the content providing system 500.

As described above, the constituent elements of the information keyword providing system 100 may be combined into various types for providing the information keyword.

Hereinafter, various types of information keyword and information content providing methods (hereinafter, for better comprehension and ease of description, referred to as “information keyword providing methods”) will be described in detail based on the above-described structure of the information keyword providing system 100.

Initially, in the information keyword providing method according to an exemplary embodiment of the present invention, a process of setting an information keyword will be described. The information keyword may be set by a content creator, a content provider, a content distributor that distributes the content, and a content user that uses the content. When the content creator creates the content, or when the content creator stores or uploads the content in a network, the information keyword may be set. Herein, the process of setting the information keyword with respect to the complete content or a portion of the content through a separate process in a state where the content is being output will be described.

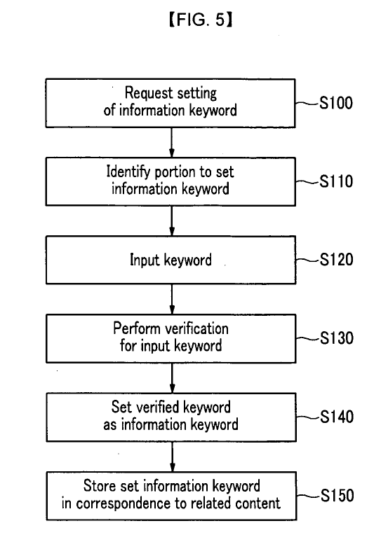

FIG. 5 is a flowchart illustrating a process of setting an information keyword according to an exemplary embodiment of the present invention.

In this instance, it is assumed that predetermined content is being provided for a user. For example, it may be a situation where the user accesses a predetermined website and thereby image content or moving image content is being played via a content providing system of the website.

The content output unit 63 of the output processing server 60 according to an exemplary embodiment of the present invention may additionally display an “information keyword setting button” around a content display region to be used by users that desire to set the information keyword.

When there is no information keyword of a target that is displayed on a particular portion of playing content, or when an information keyword exists but a user desires to set, correct, or delete a new information keyword, the user may manipulate the information keyword setting button to thereby request an information keyword related operation.

When the information keyword setting button is operated, the keyword setting unit 11 of the keyword management server 10 determines that the user desires to set the information keyword in operation S100. In a state where a separate input window for enabling the user to select a predetermined portion of content is provided, or in a state where the user pauses playing of the content, the user identifies a portion where the user desires to set the information keyword in the content through a process of identifying the predetermined portion of the content via a mouse in operation S110. For example, when the user pauses playing of content in a particular play time of the content and clicks, via mouse, on a portion corresponding to clothes that a character wears in the content on the paused screen, it is determined the user desires to set an information keyword in a corresponding location. In this case, order of operations S100 and S110 may be changed. For example, after identifying the portion of content of which the user desires to set the information keyword, a request for setting the information keyword may be input according to manipulation of the information keyword setting button.

As described above, when the portion of which the user desires to set the information keyword is identified, the keyword setting unit 11 provides a tool for enabling the user to input the information keyword. For example, a keyword input window is provided. Next, when the user inputs the desired information keyword via the keyword input window, for example when the user inputs at least one of a brand name of the clothes, features thereof, information on stores selling the clothes, price information, etc., the keyword setting unit 11 receives the input keyword in operation S120.

The keyword setting unit 11 may directly set the received keyword as an information keyword related to a corresponding portion of content, without a separate verification process. However, according to an aspect of the present invention, the separate verification process is performed in operation S130, in order to set, as the information keyword, a keyword that is more appropriate for the content and can give more reliable information.

Specifically, the keyword setting unit 11 provides the input keyword to the keyword verification unit 12 for verification request. Initially, the keyword verification unit 12 verifies whether the input keyword is appropriate as the information keyword. Based on maintaining materials corresponding to keyword verification standards, or based on connection with another verification apparatus (not shown) that is connected via a network, the keyword verification unit 12 may determine whether the input keyword is appropriate as the information keyword. For example, when the input keyword is inappropriate for the content, when the input keyword includes provocativeness, violence, racism, and the like, or when the input keyword has a problem of a copyright infringement, the keyword verification unit 12 determines the corresponding keyword is inappropriate as the information keyword, and transfers the result thereof to the keyword setting unit 11.

Also, the keyword verification unit 12 verifies whether the input keyword is the same as or similar to existing set information keywords. Specifically, the keyword verification unit 12 compares the input keyword to the existing information keywords stored in the information keyword database D2 and determines whether they are similar to each other. When the input keyword is the same as or similar to the stored information keywords, the keyword verification unit 12 transfers the result thereof to the keyword setting unit 11.

Also, when the input keyword is appropriate as the information keyword, or when the input keyword is different from the existing information keywords, the keyword verification unit 12 transfers, to the keyword setting unit 11, a verification result informing that the input keyword may be set as the information keyword.

In operation S140, the keyword setting unit 11 sets the finally input keyword as the information keyword based on the above keyword verification result. In operation S150, the set information keyword is assigned a keyword ID number and then is stored and managed in the information keyword database D2. Also, in correspondence to the keyword ID number of the information keyword, a unique number of contents where the information keyword is used and a serial number indicating which portion of the content is being used may be stored. In addition, user information of a user inputting the information keyword may be stored. The stored information may be used as basic information when the user later desires to search the set information keyword.

The information keyword set as above may be output together when the corresponding content is output, or may be output to provide related information when a request is received from a user using the content.

An editing process such as correction, addition, deletion, etc. may be performed for information keywords set as above. The editing process may be performed by a user inputting a corresponding information keyword, or by a keyword manager, and the like.

The above-described information keyword setting process has been described based on, as an example, a state where a corresponding content is being output, but the present invention is not limited thereto. The process may be performed in a state where the content is not output. For example, when a time point to play a portion of content where an information keyword is set is known, it is possible to operate the information keyword setting button, input a play time point, and thereby set the information keyword with respect to the corresponding portion as described above.

Also, a keyword setting process according to an exemplary embodiment of the present invention may be automatically performed without involving a user or a manager.

Hereinafter, in the information keyword providing method according to an exemplary embodiment of the present invention, a process of verifying an information keyword will be further described in detail.

The information keyword verifying process according to an exemplary embodiment of the present invention may be performed by using the keyword verification unit 12.

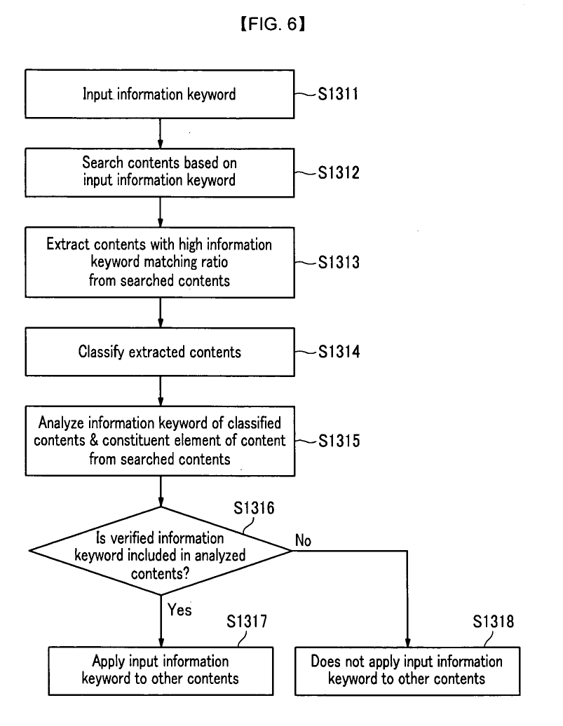

FIG. 6 is a flowchart illustrating a process of verifying an information keyword according to a first example of an exemplary embodiment of the present invention.

As described above, when an information keyword requiring verification is provided from the keyword setting unit 11 in operation S1311, the keyword verification unit 12 searches the content database D1 and the information keyword database D2 based on the provided information keyword to thereby search content including an information keyword related to the provided information keyword in operation S1312. In operation S1313, the keyword verification unit 12 extracts contents with high information keyword matching ratios from the searched contents. Specifically, the keyword verification unit 12 searches content including at least one information keyword, from constituent elements constituting the information keyword provided from the keyword setting unit 11. The constituent elements include any type that constitutes the information keyword, for example text, an image, audio, a moving image, etc. Next, the keyword verification unit 12 extracts, from the searched contents, content with an information keyword matching ratio with the set information keyword that is greater than a predetermined set value.

More specifically, the keyword verification unit 12 uses a plurality of information keywords set in single content to thereby extract contents that match the plurality of information keywords. For example, when a verification request is received for information keywords A, B, C, and D of single first content, all second contents that include all the information keywords A, B, C, and D, or a portion thereof are searched using “A and B and C and D, A or B or C or D, A and B or C or D”, etc. that is used in a general search engine. Here, that the verification request is received for the plurality of information keywords such as A, B, C, and D of the first content has been described as an example. Also, when the first content includes a single information keyword and a verification request is received for the information keyword, the search is performed in the same way. A matching ratio between information keywords of the first keyword and information keywords of the second content may be defined as the information keyword matching ratio.

Also, a different weight value is assigned to each information keyword, for example A=1, B=0.5, C=0.3, and D=0.1. Thus, although the matching ratio is the same, content that includes an information keyword with a higher weight value may be searched for each rank. The above search method is already known technology in the related art and thus further detailed descriptions will be omitted here.

In operation S1314, the keyword verification unit 12 classifies the extracted contents as the same or similar contents based on information such as the keyword matching ratio, content size (capacity), content type, a copyright holder, a creator, and the like. When the extracted contents are classified, that is, determined as the same content, verified information keyword information of the same content may be applied to corresponding content as is. As necessary, non-verified information keyword information may be applied. Also, when using the same content without separately storing a corresponding content, or when there is a request for usage of the corresponding content with maintaining a unique number of corresponding contents but not storing the corresponding contents in association with connection information of the same content, it is possible to provide the same content based on the connection information of the same content.

In operation S1315, the keyword verification unit 12 analyzes an information keyword of the classified same/similar contents and content portion information (a frame in the case of a moving image). More specifically, partial information of content corresponding to an information keyword may be obtained by analyzing location information of a portion of content that is included in the information keyword and corresponds to the information keyword, and unique information (color, contrast, resolution, etc.) of the portion of the content. Through this, it is possible to identify only a required portion from a plurality of information keywords corresponding to the portion of content and again verify information keyword correlation with other content using the identified portion.

In operations S1316 and 1317, when a verified information keyword corresponding to partial information of particular content is included in partial information of the analyzed contents, the keyword verification unit 12 simultaneously applies the input information keyword to other contents. Based on the information keyword and partial information of the content corresponding to the information keyword that are obtained through the above operations S1313 to S1315, when information keywords of a plurality of contents are the same as or similar to partial information of the content corresponding to the information keyword, the keyword verification unit 12 searches a verified information keyword from the information keywords of the contents. When the verified information keyword exists as a result of a search, the keyword verification unit 12 applies the verified information keyword to information keywords of the contents and partial information alike. Here, the verified information keyword may be the same as or different from the information keyword that is requested for verification in operation S1311. Through the above process, keyword verification may be performed and the verified keyword may be applied to content.

Through this, it is possible to automatically set or compare an information keyword applied to the same or similar content. When a verified information keyword exists, it is possible to simultaneously apply the verified information keyword to a plurality of contents and thereby reduce management and maintenance effort.

In operation S1318, when the corresponding information keyword is not verified, the input information keyword is not applied.

Also, it is possible to verify an information keyword based on a predetermined evaluation score of the information keyword.

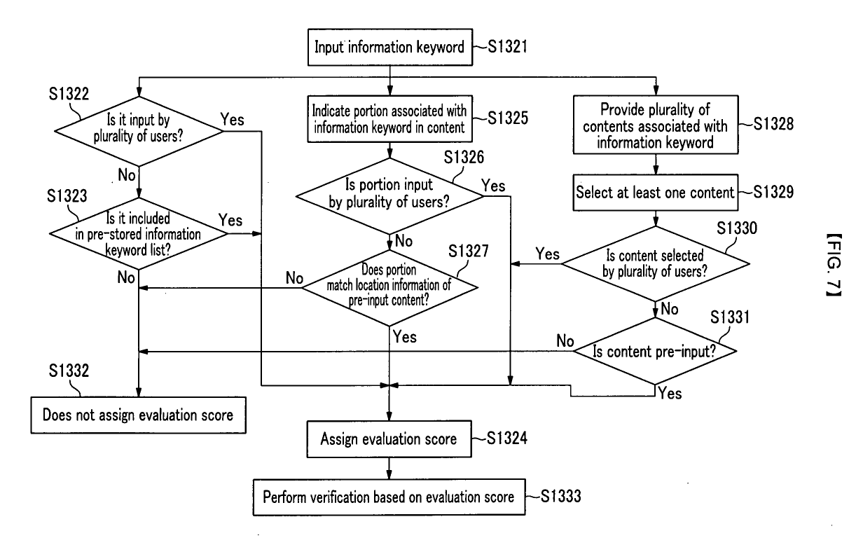

FIG. 7 is a flowchart illustrating a process of verifying an information keyword according to a second example of an exemplary embodiment of the present invention.

In operation S1321, a user inputs an information keyword related to content. In this instance, a plurality of other users may input an information keyword. When the input information keyword is input by the plurality of users in operation S1322, or when the input information keyword is included in a pre-stored information keyword list in operation S1323, a predetermined evaluation score is assigned to the information keyword in operation S1324.

Also, in operation S1325, when the user offers a random information keyword, the user is enabled to indicate a portion associated with the offered information keyword in the corresponding content. The above case corresponds to a case where the user offers the information keyword after outputting the content.

When the user indicates a predetermined portion of the content in correspondence to the offered information keyword, and in this instance the indicated portion is a value input by the plurality of users, that is, a portion selected by the plurality of users in order to assign an information keyword, or is a portion associated with information keywords input by the plurality of users in operation S1326, or when the indicated portion matches location information of a pre-input content in operation S1327, the evaluation score is assigned to the corresponding information keyword in operation S1324. In this instance, the location information denotes location information of content that is pre-input by an information keyword manager, a content creator, a content distributor, and the like, in correspondence to the information keyword.

In operation S1328, a plurality of contents (e.g., three to five contents) associated with the input information keyword are provided for the user, to thereby request the user to select at least one content matching or not matching the input information keyword. When the user selects, from the plurality of contents, at least one content matching or non-matching the information keyword according to the request in operation S1329, the evaluation score is assigned to a corresponding information keyword according to the selected content. Specifically, when corresponding content is a value selected by majority, that is, content selected by the plurality of users in operation S1330, or when the corresponding content is a value that is pre-input by a system, that is, content selected by the system in correspondence to the input information keyword in operation S1331, the evaluation score is assigned to the corresponding information keyword in operation S1324.

The evaluation score is assigned through the above operations. Conversely, when the above-described conditions are not satisfied, the evaluation score is not assigned in operation S1332.

In operation S1333, verification is performed based on the evaluation score assigned to the corresponding information keyword. For example, when the evaluation score is greater than a predetermined value, it may be determined that the corresponding information keyword has reliability as an information keyword. Conversely, when the evaluation score is less than the predetermined value, it may be determined that the corresponding information keyword does not have reliability as the information keyword.

Also, when outputting content and an information keyword, it is possible to simultaneously display the evaluation score together. In this case, when a plurality of information keywords correspond to a predetermined portion of content, the plurality of information keywords may be sorted in a descending order or an ascending order of the evaluation score.

Also, it is possible to sort contents and information keywords in a descending order or an ascending order of each evaluation score of a corresponding information keyword.

In addition to the above process of assigning the evaluation score, when moving image content is provided, a particular information keyword or a sentence associated with the information keyword is provided. Every time a portion associated with the particular information keyword or the sentence is output while using the moving image content, the user indicates the portion. When the indicated value is a value input by the plurality of users or a value pre-input by the system, the evaluation score may be assigned. For example, the user may perform the indication operation by clicking on the portion associated with the particular information keyword or sentence using a mouse, or by locating a mouse cursor at the portion. When the indicated portion is a portion indicated by the plurality of users or a portion designated by the system as a portion associated with the information keyword or sentence, the system assigns the evaluation score to the corresponding user.

The information keyword providing system may assign the evaluation score to an information keyword offered by a user using at least one of the aforementioned evaluation score assigning schemes.

In addition to the above-described verification process, it is possible to verify an information keyword or information content by an expert. Specifically, when setting an information keyword or information content of a particular field, a verification expert (e.g., an expert of the corresponding field, a user with a high information keyword setting/verification rate, etc.) is informed. Next, when the verification expert informs the verification result of the information keyword or information content, it is possible to set the information keyword or information content based on the verification result. The above process may be performed after setting of the information keyword or information content is completed. In this case, it is possible to correct, add, or delete the information keyword or information content based on the verification result.

Also, instead of the expert, general users may verify the information keyword or information content. Specifically, general users unassociated with the information keyword may correct the information keyword or information content. In this case, a correction button may be provided. A general user prepares materials (e.g., news, a universal resource locator (URL), an image, video, etc.) required for changing a predetermined information keyword or information content, and reviews appropriateness of the prepared materials. When the materials are reasonable, it is possible to correct the information keyword or information content based on the materials. The general user transmits the obtained result to the information keyword providing system. The information keyword providing system adds, corrects, or deletes the information keyword or information content based on the transmitted result.

Also, a copyright holder, and a provider or user of a corresponding product or service may perform the above process. The provider or user denotes a provider of a corresponding product or service in content, or a user that uses the product or service in the content. For example, in the case of an information keyword associated with boots Madonna wears in a concert video, Madonna corresponds to “the user”. Thus, using this, it is possible to perform information keyword verification. In this instance, the provider or user of the corresponding product or service may be referred to as a “concerned party”, for example an entertainer agency, an entertainer, an entertainer coordinator, a drama FD, a sponsor, etc. Specifically, content, and an information keyword and information content corresponding to the content, are transmitted to the copyright holder or the concerned party. The copyright holder or the concerned party uses the transmitted content. Also, the copyright holder or the concerned party adds, corrects, or deletes the information keyword or information content corresponding to the content. When the operation result is provided to the information keyword providing system, the information keyword providing system reflects the result in its managing content, and information keyword and information content.

Hereinafter, in the information keyword providing method according to an exemplary embodiment of the present invention, a process of correcting, adding, or deleting an information keyword will be described.

Through the above-described process, users may correct or delete a corresponding information keyword with respect to information keywords that are set and managed in association with content. As necessary, the users may add a predetermined information keyword. Hereinafter, editing of an information keyword means adding, deleting, or correcting of the information keyword.

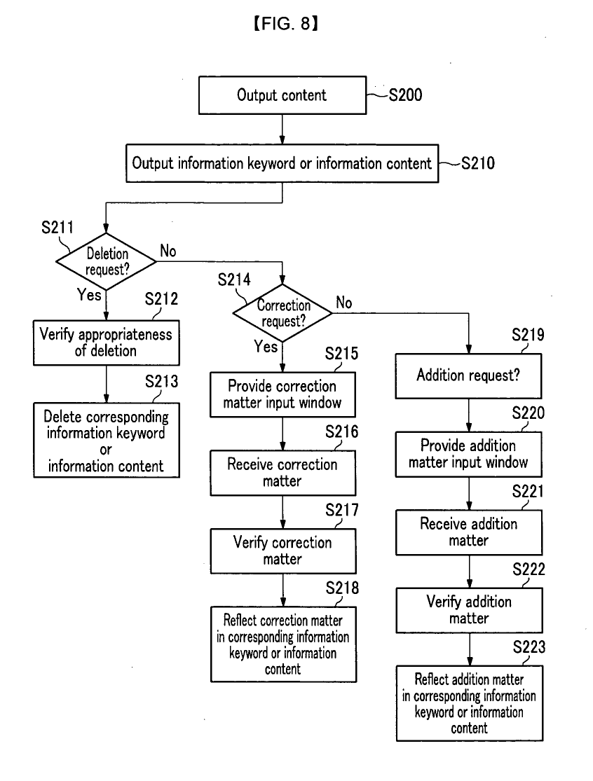

FIG. 8 is a flowchart illustrating a process of editing an information keyword according to an exemplary embodiment of the present invention.

Users using content may set or store an information keyword with respect to the content, through the above-described process of FIG. 7.

As shown in FIG. 8, in a case where a user using a predetermined content receives a related information keyword or information content in operations S200 and S210, when the user desires to delete a corresponding information keyword or information content in operation S210, the keyword setting unit 11 deletes an information keyword or information content corresponding to a corresponding content. In this case, in order to prevent indiscrete deletion, the deletion operation is performed when appropriateness for deletion of the corresponding information keyword or information content is verified in operations S212 and S213.

Also, when the user desires to correct the information keyword or information content in operation S214, the keyword setting unit 11 provides the user with an input window enabling the user to input a correction matter in operation S215. The keyword setting unit 11 reflects the input correction matters in the corresponding information keyword or information content. Also, in this case, a separate verification operation is performed in order to prevent inappropriate correction in operations S216 and 217. When appropriateness for correction of the corresponding information keyword or information content is verified, the correction operation is performed in operation S218.

Also, when the user desires to add a new matter to the information keyword or information content in operation S219, the keyword setting unit 11 provides the user with an input window enabling the user to add a predetermined matter in operation S220. The addition matter is added to the corresponding information keyword or information content. In this case, a separate verification operation is performed in order to prevent inappropriate addition in operations S221 and S222. When appropriateness for addition of the corresponding information keyword or information content is verified, the addition operation is performed in operation S223.

As a verification scheme for deletion, correction, or addition of an information keyword or information content, verification schemes used in the above verification process may be used. In addition, various other schemes may be used.

As described above, when deletion, correction, or addition for an information keyword or information content related to predetermined content is performed, the keyword setting unit 11 reflects related matters in the content database D1 and/or the information keyword database D2. Thus, a subsequently accessing third user is provided with an edited information keyword or information content.

Hereinafter, in the information keyword providing method according to an exemplary embodiment of the present invention, a process of connecting and registering an information keyword and information content will be described.

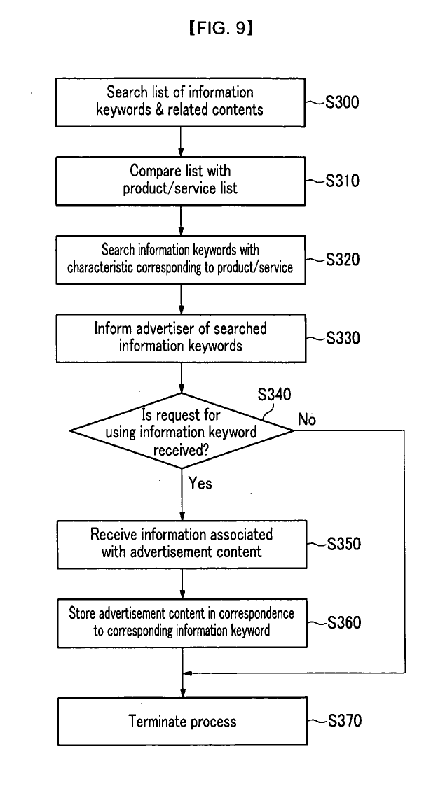

FIG. 9 is a flowchart illustrating a process of connecting and registering information content, particularly advertisement content, and an information keyword according to an exemplary embodiment of the present invention.

As shown in FIG. 9, the advertisement search unit 41 of the advertisement management server 40 according to an exemplary embodiment of the present invention searches the content database D1 and the information keyword database D2 for a list of set and registered information keywords and related contents, and transfers the search result to the advertisement host unit 42 in operation S300.

In operation S310, the advertisement host unit 42 searches the search result for information keywords that have characteristics corresponding to product/service lists provided from advertisers. For example, in operation S320, the advertisement search unit 41 may search information keywords with a characteristic associated with a product or service of an advertiser using a scheme of searching information keywords that includes a word corresponding to the product or service, and the like. When the information keyword or content with the characteristic matching the product or service is searched as a result of comparison and analysis between the list of information keywords and related contents, and the product/service lists, the advertisement host unit 42 informs this to an advertiser that desires to advertise a corresponding product or service in operation S330. For example, the advertisement host unit 42 transfers, to the advertisement system 400 of the advertiser, an ID number of the corresponding product or service and information associated with the related information keyword or content.

Also, according to an advertiser request, a search for an information keyword or content related to a predetermined product or service may be performed. In this case, when an advertiser inputs a search word related to the product or service, the advertisement search unit 41 may search the content database D1 and the information keyword database D2 using the search word, and transfer the search result to the advertiser using the advertisement system 400 of the advertiser with the advertisement host unit 42, or using another scheme. In this case, without using the advertisement host unit 42, the advertisement search unit 41 may directly transfer the search result to the advertiser using the advertisement system 400 or another scheme.

When a request for connecting the information keyword or content with the product or service and thereby using the same is received from the advertisement system 400 in operation S340, the advertisement host unit 42 receives information associated with the advertisement content and registers the same in correspondence to the information keyword or content in operations S350 and S360. For example, an ID number of the information keyword is stored and managed in correspondence to the corresponding information keyword of the information keyword database D2. Therefore, when the user later receives the corresponding information keyword and then requests an advertisement, the advertisement content corresponding to the ID number that is stored in the advertisement content database 420 of the advertisement system 400 is provided.

When the advertiser makes a request for connecting advertisement content with a predetermined information keyword or content and using the same in operation S340, the advertisement payment unit 43 of the advertisement management server 40 may set detailed conditions, for example an advertisement placement condition, etc., and perform cost payment based on the conditions. Also, when a contract is made according to payment, advertisement content is registered in correspondence to the corresponding information keyword or content, as described above.

As aforementioned, connecting advertisement content with an information keyword or content may be performed according to an advertiser request, and may also be periodically performed every time a new information keyword is set by the advertisement management server 40.

Hereinafter, in the information keyword providing method according to an exemplary embodiment of the present invention, a process of providing an information keyword when outputting content will be described.

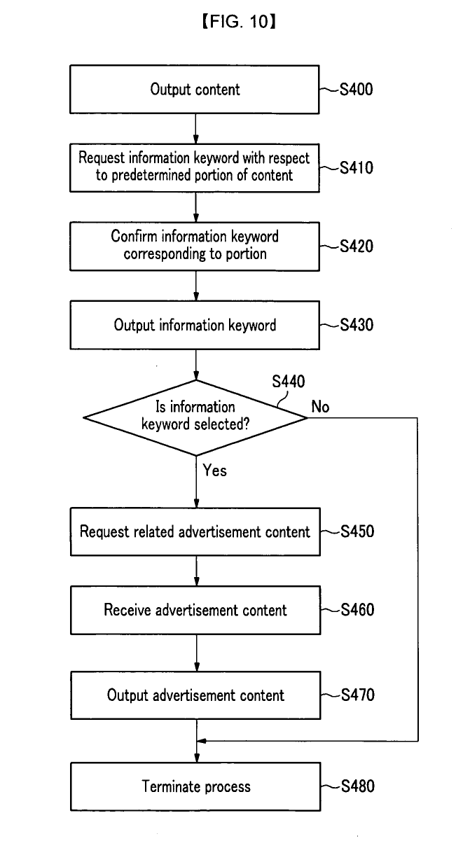

FIG. 10 is a flowchart illustrating a process of providing an information keyword and information content, particularly advertisement content, when outputting content according to an exemplary embodiment of the present invention.

When outputting content in a form of an image or moving image using a web service or a broadcasting service via a network, the content providing system 500 may provide a user with the content in interoperation with the information keyword providing system 100 according to an exemplary embodiment of the present invention.

When a user viewing the output content requests an information keyword by clicking on a predetermined portion of the content using a mouse, or a separate process in operations S400 and S410, the content identification unit 61 of the output processing server 60 identifies, from the selected content, a portion including the information keyword or the portion selected by the user. For example, in operation S420, the content identification unit 61 may confirm whether the information keyword is included based on information that is stored in correspondence to the content of the content database D1 to thereby easily identify the portion corresponding to the information keyword.

When the portion corresponding to the information keyword is identified from the content, the keyword allocation unit 62 searches the information keyword database D2 for the information keyword corresponding to the identified portion and allocates the searched information keyword. In operation S430, while outputting the content, the content output unit 63 adds and outputs the allocated information keyword. In this case, the content output unit 63 may fixably output the information keyword or a predetermined advertisement phrase for a predetermined period of time. For example, in the case of mouse-over, the content output unit 63 may output the information keyword or the advertisement phrase using a ticker bar for the predetermined period of time (e.g., 0.5 seconds). Next, even though a mouse cursor is moved, the content output unit 63 may output the information keyword or the advertisement phrase for the predetermined period of time (e.g., five seconds) without changing the information keyword or advertisement phrase. In this instance, if the mouse-over occurs again and continues for a predetermine period of time (e.g., five seconds), the displayed information keyword or advertisement phrase may be changed.

Through the above process, the user viewing the output content may also view the information keyword allocated to the predetermined portion of the content.

When the user clicks on the output information keyword, information content or advertisement content corresponding to the information keyword is output. More specifically, when the information keyword is selected, the output processing server 60 transfers an ID number of the information keyword to the advertisement connection server 50 and requests output of the advertisement content that is one of information contents in operations S440 and S450.

While transferring the ID number of the information keyword to the advertisement system 400, the advertisement connection server 50 requests related advertisement content. Also, while transferring an ID number of advertisement content corresponding to the information keyword of the information keyword database D2 to the advertisement system 400, the advertisement connection server 50 requests related advertisement content.

Accordingly, the advertisement system 400 searches the advertisement content database 420 for the advertisement content corresponding to the keyword ID number or the ID number of the advertisement content, and transfers the searched advertisement content to the advertisement connection server 50. In operations S460 and S470, the advertisement connection server 50 transfers the transferred advertisement content to the information content output unit 64, and the information content output unit 64 outputs the advertisement content. Accordingly, the user may readily receive the advertisement content connected with the information keyword.

For example, when a predetermined character is selected from predetermined content, an information keyword (e.g., information associated with accessories or clothes the character wears, or a product name or brand name, etc.) corresponding to the selected character is provided. When the user clicks on the information keyword, a user terminal is connected to a homepage of an advertiser that provides advertisement content associated with the information keyword whereby the user receives the advertisement content.

Unlike the above process, when the information keyword is selected, the output processing server 60 may search the information keyword database D2 for information content associated with the information keyword, based on an ID number of the information keyword, and output the searched information content via the information content output unit 64.

Also, when the content is a moving image, it is possible to indicate that an information keyword and information/advertisement content are connected with a corresponding display portion by displaying color, size, shape, etc. of a portion that is connected with the information keyword and information/advertisement content to be discerned from another portion that is not connected with the information keyword and information/advertisement content in a playbar for displaying play length of content and a current play location thereof. Also, when the portion is selected in the playbar, it is possible to directly play the selected portion in the corresponding location.

Further, when information content or advertisement content is connected with an information keyword, it is possible to indicate their connection state by flickering the information keyword itself when outputting the same, or by activating a separate button.

In addition, the user may purchase a product or service associated with the information keyword. For example, when the user selects a separately provided purchase button while selecting the information keyword, or when the user selects a purchase for the product or service while receiving an information content or advertisement content associated with the information keyword, a payment process for the selected product or service may be performed. Payment information that includes particulars regarding the purchased product or service may be transferred to and managed by the revenue distribution server 70. The payment information is used later as data for revenue distribution. The payment scheme is known in the related art and thus further detailed descriptions related thereto will be omitted here.

The aforementioned process of outputting the information keyword or information content related to the content may be performed according to a user request, or may be automatically performed regardless of the user request. Specifically, it is possible to output the information keyword by automatically identifying that the information keyword is allocated to the related content.

Also, it is possible to output the information keyword or information content or the advertisement content related to the content by transmitting both the information keyword (or an information keyword list) and information (e.g., connection URL) of the information content related to the information keyword when transmitting the content to the user terminal.

In this case, an amount of the transmitted information keyword and information content associated with the information keyword may be determined according to a content download scheme. For example, when temporarily downloading the content in the user terminal and then using the downloaded content, information associated with the information keyword and information content may be simultaneously transmitted to the user terminal. Also, when transmitting the content using a buffering scheme, it is possible to transmit information associated with the information keyword and information content that is consistent with an amount of transmitted content using the buffering scheme. As described above, when the information keyword or information content related to the content is output, searching of information keywords may be performed based on the downloaded information keyword list without additional communication with the system. Specifically, it is possible to search a predetermined information keyword from the downloaded information keyword list. Without additional communication with the system, a connection to information content with respect to predetermined content may be directly performed based on downloaded information (e.g., connection URL) associated with the information content of a user terminal.

According to an exemplary embodiment of the present invention, it is possible to adjust play speed or resolution of content so that a user may more readily identify an information keyword.

For example, when the content is a moving image, it is possible to discern a frame including an information keyword from a frame excluding the information keyword by playing a corresponding frame at a lower speed than an original play speed, that is, a reference play speed. Particularly, in this case, it is possible to slow down the play speed from the reference play speed, from a predetermined point in time before or after the frame including a portion corresponding to when the information keyword is played.

Also, in a case where the content is a moving image or a still image, when playing a portion of content including a portion corresponding to an information keyword, it is possible to discern the portion of the content including the information keyword from a portion of the content excluding the information keyword by playing the portion of the content at higher resolution than original resolution, by flickering the entire screen or a portion of the screen, or by changing color, size, etc. of the screen. Hereinafter, for better comprehension and ease of description, a portion of content is referred to as a “constituent portion of content”. When the content is a moving image, the constituent portion of content may be a frame.

Also, when playing the constituent portion of content including a portion corresponding to an information keyword, it is possible to enlarge the information keyword and play the enlarged information keyword, so that a user may easily identify the information keyword. In this case, it is possible to enlarge the information keyword and the portion corresponding to the information keyword.

Also, as described above, when playing the constituent portion of content including the portion corresponding to the information keyword (e.g., frame in the case of moving image), it is possible to adjust the play speed and the resolution. For example, while playing the constituent portion of content at a lower speed than a reference play speed, it is possible to play the constituent portion of content at higher resolution than reference resolution corresponding to original resolution. In this case, as shown in the movie “Matrix” where cameras rotate to slow down a play speed when a main actor is avoiding a bullet, a similar effect to bullet time may be provided to enable a user to closely view the constituent portion of content.

Also, as described above, when playing the constituent portion of content including the portion corresponding to the information keyword, it is possible to play separate complementary content with respect to the portion corresponding to the information keyword in a separate space excluding the content display region. Here, the complementary content may be any one of text, an image, and a moving image with revised resolution, and so on with respect to the portion corresponding to the information keyword, and a combination thereof.

Also, as described above, when playing the constituent portion of content including the portion corresponding to the information keyword, it is possible to indicate the portion of content corresponding to the information keyword in the form of a diagram such as a circle, an icon, a cursor, text, etc., according to a user request. Through this, it is possible to inform that the information keyword, information content related thereto, advertisement content, etc., are combined in the corresponding content region. The above operation may be performed according to the user request, or may be automatically performed regardless of the user request. Specifically, as described above, it is possible to automatically identify that the information keyword is allocated to the related content and thereby indicate the portion of content with the allocated information keyword using a diagram, an icon, a cursor, text, etc.

Through the above-described process, users may more easily and effectively identify the information keyword.

In addition, it is possible to provide advertisement content based on information associated with an information keyword. For example, when the content is a moving image, it is possible to separately construct a text or a screen using an information keyword before, while, or after playing the moving image. As an example, when an information keyword includes Madonna, beverage, cantata, etc., it is possible to provide advertisement content using a preview or a teaser scheme such as “beverage Madonna drinks in this moving image is cantata”, etc., prior to playing the moving image.

Also, it is possible to provide other content and advertisement content related thereto based on information associated with an information keyword of particular content. For example, when the content is a moving image and the field of content is a performance, it is possible to provide other content associated with the performance. Also, before, while, or after playing the moving image using an information keyword of the other content associated with the performance, it is possible to provide advertisement content constructed as a separate sentence or screen using the information keyword. For example, when the information keyword includes Madonna, performance, live, etc., it is possible to search popular content using the information keyword and use information keywords of the searched content to thereby provide related content or advertisement content such as “Madonna always loves cantata for best performance”, “necessity for fabulous performance”, etc., while playing the moving image.

Also, based on user information, it is possible to selectively output an information keyword and information content when using content. Specifically, it is possible to analyze pre-stored user information (e.g., sex, age, residence area, job, and hobby), particulars of services currently used by a user, etc., and select an information keyword and information content type based on the analysis result. Also, it is possible to provide an information keyword and information content selected when the user uses the content.

As described above, after receiving an information keyword and/or information content online, that is, via a network, particularly advertisers among users may use the information keyword and/or information content offline.

Hereinafter, an example of using content based on an information keyword according to an exemplary embodiment of the present invention will be described.

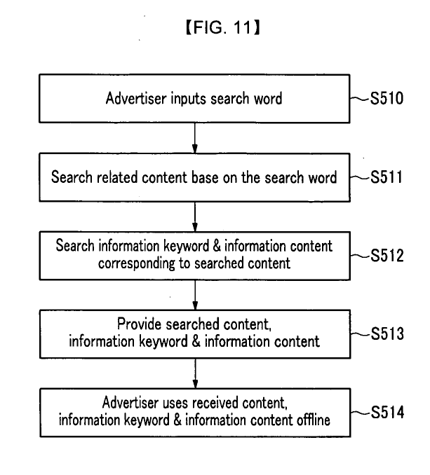

FIG. 11 is a flowchart illustrating a usage example of content according to an exemplary embodiment of the present invention. Here, a case where an advertiser uses the content has been described as an example, but the present invention is not limited thereto.

As shown in FIG. 11, when an advertiser accesses the information keyword providing system 100 to input a search word (here, it may be an information keyword), the keyword search server 80 searches the content database D1 and/or information keyword database D2 for related content, based on the input keyword in operations S510 and S511. For example, the keyword search server 80 searches content with an information keyword including the complete input search word or a portion of the input keyword, or content related to a product or service associated with the input search word.

In operation S512, the keyword search server 80 searches an information keyword and information content corresponding to the searched content. In operation S513, the keyword search server 80 transmits the searched content, information keyword, and information content to the advertiser via a network.

In operation S514, the advertiser may use the received content, information keyword, and information content offline, and may also add and use separate content. In this instance, when providing content so that the advertiser may use the content offline, it is possible to provide matters related to the corresponding content only when the advertiser completes a payment process. Accordingly, it is possible to create new revenues according to usage of content, and an information keyword and information content related thereto.

In the aforementioned example, the keyword search server 80 performs a search, but another constituent element of the information keyword providing system 100 may perform a search.

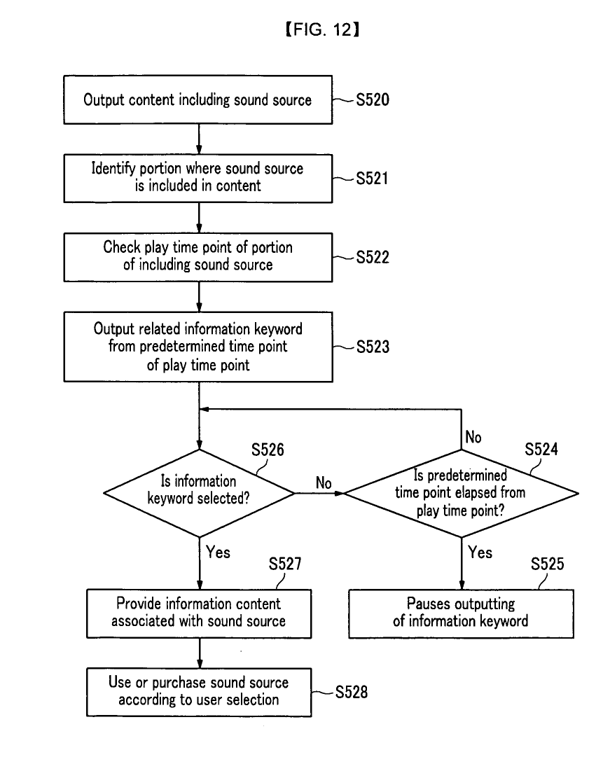

FIG. 12 is a flowchart illustrating another usage example of content according to an exemplary embodiment of the present invention.

In a state where a user is using content as shown in FIG. 10, when a sound source is included in the outputting content as shown in FIG. 12, the content output unit 63 of the output processing server 60 identifies a portion where the corresponding sound source is being played in operations S520 to S522. More specifically, it is determined whether an audio file or a video file includes the sound source in a file format of the outputting content, or whether an information keyword or information content combined with the content includes sound source information. When the audio file or video file is searched, or when the information keyword or information content is searched, it is possible to identify a play start time point, a play end time point, a play length, etc. of the sound source using the searched audio file or video file including the sound source, or using a tag that is input in the searched information keyword or information content in association with the sound source information.

In operation S523, from a predetermined time point based on the play time point of the identified portion, an information keyword corresponding to the sound source is output. In operations S524 and S525, the information keyword associated with the sound source starts being output from the predetermined point in time before the sound source is played, and outputting of the information keyword is maintained by the predetermined time point after playing of the sound source is completed.

As described above, in a state where the information keyword associated with the sound source is being output, when the user selects the information keyword by clicking on the information keyword using a mouse in operation S526, the content output unit 63 outputs information content associated with the sound source corresponding to the information keyword in operation S527. Accordingly, when the user terminal receives the information content, the user terminal is connected to, for example, a webpage corresponding to a URL that provides the information content associated with the sound source.

In operation S528, via the information content associated with the sound source, the user may purchase the sound source, or may use a sound source sample, etc., or may make a query in association with the sound source. A query associated with a sound source and an answer thereto may be performed by a query and answer process, which will be described later.

Accordingly, it is possible to create new revenues according to usage of sound source using content including the sound source and an information keyword related thereto.

Hereinafter, in the information keyword providing method according to an exemplary embodiment of the present invention, a process of performing a query and answer with respect to an information keyword will be described.

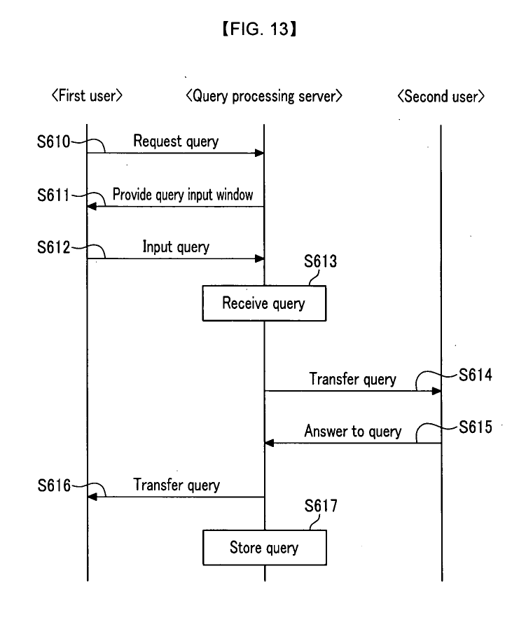

FIG. 13 is a flowchart illustrating a query and answer process with respect to an information keyword according to a first example of an exemplary embodiment of the present invention.

According to an exemplary embodiment of the present invention, when an information keyword related to content is provided, a user may make a query with respect to the content or the information keyword. For this purpose, a separate space is provided inside or outside a content display region. For example, a query button may be provided around a content play window.

As shown in FIG. 13, when a first user asks a query while content is being output, a query processing server 30 provides a separate tool for indicating a particular portion of content or for inputting a query. For example, when the user indicates a particular portion of content using a mouse, etc., an input window enabling the user to input the query is provided. In this instance, a per-query category is provided together so that the first user may select a category that includes a desired query. When the outputting content is a moving image, the query processing server 30 requests the output processing server 60 to pause playing of the content in operation S610. Thus, the content output unit 63 of the output processing server 60 pauses or slows down playing of the content and thereby facilitates input or selection of the query in operation S611.

In operations S612 and S613, when the query is input by the first user, the query reception unit 31 of the query processing server 30 receives and stores the query in the storage unit 33. In operation S614, the query reception unit 31 transfers the query to terminals of second users that are currently connected to the network 200. In this instance, the second users may be users that are connected to the content providing system 500 providing the corresponding content, or may be users that receive the same kind of contents as the first user while connected to the content providing system 500. Next, when an answer for the query is received from a second user terminal in operation S615, the answer unit 32 of the query processing server 30 transfers the answer to the first user terminal in operation S616. In operation S617, the answer obtained through the above process is managed and stored in the storage unit 33 in correspondence to the query.

According to an exemplary embodiment of the present invention, it is possible to process the query as follows.

The query reception unit 31 activates an answer button formed in a region excluding the content display region that is provided for the second users, and thereby informs the second users that the query is currently received from another user. For example, it is possible to flicker the answer button to be easily identified by the second users.

Accordingly, when the second users activate the answer button, the answer unit 32 provides an input window for inputting the answer, receives the input answer via the input window, and transfers the answer to the first user terminal. The received answer is stored and managed in the storage unit 33.

Through the above process, in a state where the first user is receiving the content, the user may easily input a query with respect to matters related to content or information keyword, or may receive an answer to the query.

In addition to the aforementioned process, it is possible to perform the query and answer process with respect to the information keyword using another process.

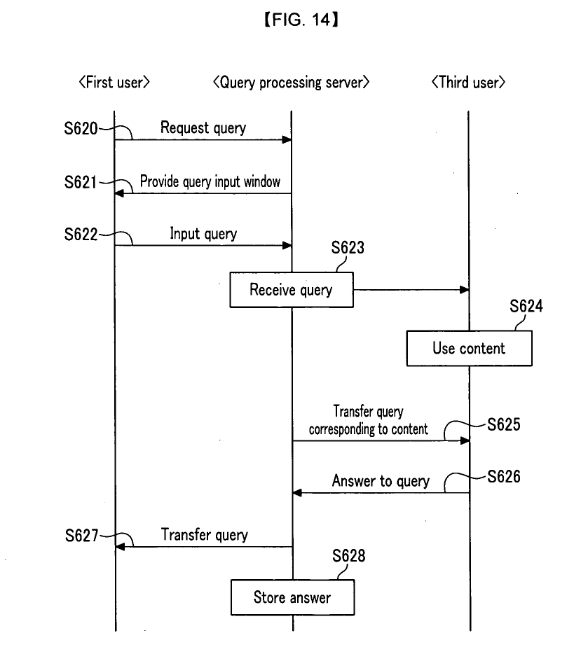

FIG. 14 is a flowchart illustrating a query and answer process with respect to an information keyword according to a second example of an exemplary embodiment of the present invention.

As shown in FIG. 14, when the query is received from the first user through the same process as operations S610 to S612 of FIG. 13 in operations S620 to S622, the query reception unit 31 of the query processing server 30 receives and stores the query in the storage unit 33 in operation S623. When a third user uses the corresponding content later in operation S624, the query reception unit 33 outputs the content and the stored query in operation S625.

In operations S626 and S627, when an answer is received from a terminal of the third user, the answer unit 32 of the query processing server 30 transfers the answer to the terminal of the first user. In operation S628, the input answer is stored and managed in the storage unit 33.

Through the aforementioned process, the first user may receive an answer from users that are connected to a system via a network at a point in time when the first user inputs a query, and may also receive an answer from users that are not connected to the network.

In the processes shown in FIGS. 13 and 14, when the user accesses the information keyword providing system 100 or content providing system 500, the answer for the query may be transmitted using a scheme of transmitting an answer result to a user terminal, and also using an email, a short messaging service (SMS) message, a text, a messenger, etc. after using the content.

Also, in the aforementioned processes, the query and answer process with respect to the content or information keyword is performed in a state where the content is being provided, but the present invention is not limited thereto. Specifically, when the user creates content and then uploads the content, it is possible to provide a query related to the content. In this case, the query reception unit 31 of the query processing server 30 stores the query that is transmitted together with the uploaded content in the storage unit 33 and manages it. As shown in FIG. 9, when providing the content for accessing users, a keyword manager, etc., it is possible to provide the corresponding query together and thereby receive an answer to the query. The answer to the query may be transmitted to the user inputting the query via an email, an SMS message, text, a message, etc.

The query and answer obtained through the aforementioned query and answer process may be converted to an information keyword and be used.

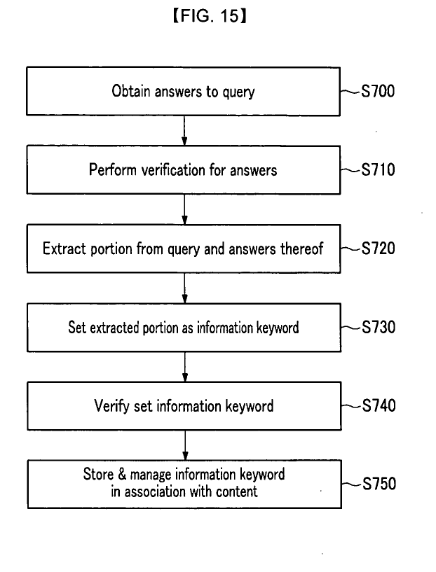

FIG. 15 is a flowchart illustrating a process of converting a query and an answer to an information keyword according to an exemplary embodiment of the present invention.

When answers are obtained through the query and answer process in operation S700, verification for the answers may be performed in operation S710. In operations S720 to S730, the keyword setting unit 11 of the keyword management server 10 extracts a portion from a query and the obtained answers thereof and sets the extracted answer as an information keyword.

In operation S740, the keyword verification unit 12 performs a verification process for the set information keyword and transfers the result thereof to the keyword setting unit 11. In operation S750, the keyword setting unit 11 may set only the verified information keyword as an information keyword related to the content, and then store and manage the information keyword in association with information content and/or advertisement content of the content and subsequently provide the information keyword when providing the content.

In this instance, verification of the answer or information keyword may be performed using the aforementioned verification scheme. As necessary, operations S710 and S740 may be omitted.

Hereinafter, in the information keyword providing method according to an exemplary embodiment of the present invention, a process of searching information keywords from content and providing the result thereof will be described.

An information keyword search according to an exemplary embodiment of the present invention may be performed with respect to a single content or a plurality of contents. Specifically, it is possible to search all the information keywords included in single content and thereby provide the result thereof, or to search portions including a predetermined information keyword from the single content and thereby provide the result thereof. Also, it is possible to search a plurality of contents including a predetermined information keyword and search a portion including the information keyword from each of the searched contents and thereby provide the result thereof.

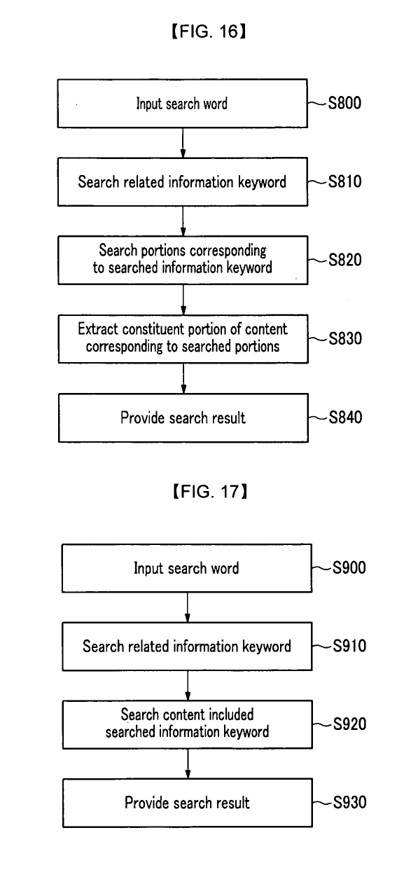

FIG. 16 is a flowchart illustrating an information keyword search process according to an exemplary embodiment of the present invention. Here, the search process will be described based on moving image contents that include an information keyword.

When a particular search word is input, the keyword search server 80 searches a portion including the search word from predetermined content. Specifically, the keyword search server 80 searches the information keyword database D2 for information keywords including the search word in operations S800 and S810. In operation S820, the keyword search server 80 searches portions including the searched information keyword by referring to the information keyword database D2 and the content database D1. The keyword search server 80 extracts constituent portions of the content corresponding to the searched portions in operation S830 and provides the search result in operation S840.

The present exemplary embodiment may provide the search result as follows.

Initially, searched portions, that is, searched portions including information keywords corresponding to a search word, are indicated in a display region for displaying a corresponding content. For example, it is possible to capture constituent elements of content corresponding to the searched portions and display reduced sub-screens in a predetermined region (e.g., a lower region) of a display region, so that a user may identify the search result. In this case, it is possible to indicate, on a sub-screen, a point in time when a constituent portion of a corresponding content is played. In this instance, when the user selects a single sub-screen, the selected sub-screen may be played to be confirmed by the user.

Secondly, a play screen is reconstructed by extracting and consecutively connecting only constituent portions of content corresponding to the searched portions. The reconstructed play screen is played so that the user may confirm the search result. For example, when a user desires to view only a portion where a predetermined character appears in a total of 30 minutes of moving image content regarding an award, the user may input a search word associated with the character. In this case, as described above, a play screen (e.g., 12 minutes) corresponding to constituent portions, that is, frames of the content that correspond to scenes where the character is appearing, are played. Accordingly, the user may effectively view desired scenes via the 12 minute play screen without the need to view all of the 30 minutes of content.

Thirdly, like a scheme for playing a constituent portion of content including a portion corresponding to an information keyword, while playing corresponding content, constituent portions of content including a searched portion may be displayed to be discerned from constituent portions of the content excluding the searched portion.

Specifically, it is possible to play the constituent portions of content including the searched portion, that is, constituent portions of first content, at a lower speed than a play speed of frames excluding the searched portion, that is, constituent portions of second content. Also, it is possible to process a resolution of constituent portions of the first content at a higher resolution than resolution of constituent portions of the second content and thereby play the constituent portions of the first content. It is also possible to increase the resolution while playing the constituent portions of the first content at a lower speed than constituent portions of the second content. Further, when it takes longer than a predetermined set time until a play time reaches a location including the constituent portions of the first content, it is possible to fast forward (e.g., at least twice the speed) the constituent portions of the second content until the constituent portions of the first content come up. In this case, when a small amount of the set time still needs to pass until the constituent portions of the first content are played, it is possible to restore the play speed of the constituent portions of the second content to the original play speed and thereby play the constituent portions of the second content.

The above search process is to search portions including a predetermined keyword from single content and provide the result thereof. Also, when searching all the information keywords included in the single content and providing the result thereof, it is possible to provide the search result as described above.

Hereinafter, a process of searching a plurality of contents including a predetermined information keyword will be described in detail.

FIG. 17 is a flowchart illustrating an information keyword search process according to another exemplary embodiment of the present invention.

When a particular search word is input, the keyword search server 80 searches all the contents for contents including a portion where the search word is included. Specifically, the keyword search server 80 searches the information keyword database D2 for information keywords including the search word in operations S900 and S910. In operation S920, the keyword search server 80 searches contents including portions including the searched information keyword by referring to the content database D1 and the information keyword database D2. In this case, although a plurality of portions corresponding to the search word are included in the single content, it is regarded that the single content is searched.

In operation S930, the keyword search server 80 outputs all the searched contents on a display region. In this instance, it is possible to simultaneously play the output contents. Also, the same as the search process of FIG. 9, when playing the searched contents, it is possible to extract, from each content, constituent portions of content-containing portions including an information keyword corresponding to the search word, reconstruct the extracted constituent portions, and play the reconstructed constituent portions. Even when playing the reconstructed constituent portions of content, it is possible to adjust play speed, resolution, etc., and thereby enable the portions corresponding to the search word to be easily identified.

Through the aforementioned search process, an information keyword desired by a user and information content related thereto are provided. Thus, it is possible to reduce the user's aversion when the user is forced to view an undesired advertisement, thereby improving the advertising effect.

The above-mentioned exemplary embodiments of the present invention are not embodied only by a method and apparatus. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of providing, by a system, an information keyword related to content via a network, the method comprising:
receiving, by the system, an information keyword request from a user terminal that receives the content;
identifying, by the system, a portion corresponding to the information keyword request from the content; and
providing, by the system, the user terminal with an information keyword corresponding to the identified portion,
wherein the providing of the information keyword comprises
displaying the portion corresponding to the information keyword to be discerned from a portion that does not correspond to the information keyword.

2. The method of claim 1, further comprising:
receiving, by the system, an information content request from the user terminal that receives the information keyword; and
providing the user terminal with information content corresponding to the information keyword.

3. The method of claim 2, wherein
the user terminal is connected to a system of an advertiser corresponding to an advertisement content included in the information content to receive the advertisement content.

4. The method of claim 2; wherein
the providing of the information content comprises additionally providing other information contents related to a field to which the information keyword belongs.

5. (canceled)

6. The method of claim 1, wherein
at least one of resolution, color, and size of the portion corresponding to the information keyword is displayed differently from at least one of resolution, color, and size of the portion that does not correspond to the information keyword.

7. The method of claim 1, wherein,
when the content is a moving image,
the content is displayed by differently processing a play speed of a frame including the portion corresponding to the information keyword from a play speed of remaining frames.

8. The method of claim 1, wherein,
when the content is a moving image,
the content is displayed by differently processing at least one of play speed and resolution of a first frame including the portion corresponding to the information keyword from at least one of play speed and resolution of a second frame.

9. The method of claim 1, wherein
the portion corresponding to the information keyword is displayed in the form of any one of a diagram, an icon, a cursor, and text.

10. The method of claim 1, further comprising
setting an information keyword with respect to the provided content,
wherein the setting comprises:
identifying, from the provided content, a portion to set the information keyword;
receiving the information keyword; and
storing and managing the received information keyword in correspondence to the identified portion.

11. The method of claim 10, wherein
a unique number is assigned to each content, a serial number associated with a unique number of a corresponding content is assigned to a predetermined portion of the corresponding content, and the received information keyword is stored and managed in correspondence to the serial number.

12. The method of claim 10, further comprising
verifying whether the received information keyword is appropriate,
wherein when it is verified that the received information keyword is appropriate, the storing and the managing stores and manages the received information keyword in correspondence to the identified portion.

13. The method of claim 12, wherein
the verifying comprises:
searching contents having an information keyword associated with the received information keyword;
extracting, from the searched contents, content with an information keyword matching ratio that is greater than or equal to a predetermined set value;
analyzing information content and content portion information of the extracted contents; and
when an information keyword corresponding to portion information of particular analyzed content is a verified keyword, applying the verified keyword to other contents.

14. The method of claim 12, wherein
the verifying comprises:
when either one of a condition that the received information keyword is input by a plurality of users and a condition that the received information keyword is one of pre-stored information keywords is satisfied, assigning a predetermined evaluation score to the information keyword;
when either one of a condition that a predetermined portion of content set with the received information keyword is selected by the plurality of users and a condition that the predetermined portion is associated with information keywords input by the plurality of users is satisfied, assigning the predetermined evaluation score to the information keyword;
providing a plurality of contents associated with the received information keyword, and when either one of a condition that content selected by a user from the provided contents is selected by a plurality of other users and a condition that the selected content is selected by the system is satisfied, assigning the predetermined evaluation score to the information keyword; and
verifying the received information keyword based on the evaluation score that is obtained through at least one of the above evaluation score assigning operations.

15. The method of claim 14, further comprising,
when a plurality of information keywords corresponds to a predetermined portion of content, displaying the plurality of information keywords that are arranged in a descending order of the evaluation score.

16. The method of claim 12, wherein:
the verifying provides the received information keyword to a content-related expert and general users excluding the expert for a verification request, and verifies the received information keyword based on an answer received in response to the verification request.

17. The method of claim 2, further comprising:
receiving a query with respect to at least one of content, an information keyword, and information content that are provided from a terminal of a first user;
transferring the received query to a terminal of at least one second user connected with the network;
receiving an answer to the query from the terminal of the at least one second user; and
transferring the received answer to the terminal of the first user.

18. The method of claim 17, wherein
the at least one second user is a user that uses a content service via the network at a point in time when the query is received,
the transferring of the query activates an answer menu to display the answer menu in a content display region and remaining regions excluding the content display region, and
the receiving of the answer receives the answer from a second user that selects the activated answer menu.

19. The method of claim 17, wherein
the transferring of the query comprises:
storing the received query in correspondence to a corresponding content, an information keyword, or information content;
providing the content, the information keyword, or the information content corresponding to the query for a terminal of a second user that accesses after reception and storage of the query is completed; and
transferring the query corresponding to the provided content, information keyword, or information content to the terminal of the second user.

20. The method of claim 17, further comprising:
extracting a portion from the query and answers thereto to set the extracted portion as an information keyword; and
storing and managing the set information keyword in association with information content and/or advertisement content of a corresponding content.

21. The method of claim 1, further comprising
connecting the advertisement content to the information keyword to register the information keyword,
wherein the registering comprises:
receiving, from an advertiser, a list of products or services that the advertiser desires to advertise;
comparing the list with stored information keywords to search an information keyword mapping the list;
receiving, from the advertiser, advertisement content associated with a product or service that maps the searched information keyword; and
registering the information keyword in correspondence to the advertisement content.

22. The method of claim 21, wherein
the receiving of the advertisement content comprises:
transferring the information keyword mapping list to the advertiser receiving a registration request for the information keyword from the advertiser; and
receiving advertisement content corresponding to a product or service that maps the information keyword requested for registration.

23. The method of claim 2, further comprising:
receiving a request for at least one editing operation of correct, delete, and add for an information keyword or an information content; and
performing the requested editing operation for the information keyword or information content.

24. (canceled)

25. The method of claim 1, wherein
the information keyword comprises at least one of additional information including information associated with coupling of the content and the information keyword, context information associated with a background and a situation of the content, and metadata associated with the content.

26. A method of searching, by a system, an information keyword when the system provides an information keyword related to content via a network, the method comprising:
receiving, by the system, a search word from a user terminal;
searching, by the system, information keywords corresponding to the search word;
searching, by the system, portions corresponding to the searched information keywords from predetermined content;
extracting, by the system, constituent portions of the content that include the searched portions; and
providing, by the system, the user terminal with the search result including the extracted constituent portions,
wherein
the providing of the search result
displays the extracted constituent portions of the content to be discerned from remaining constituent portions of the content while playing the content.

27. The method of claim 26, wherein
the providing of the search result comprises:
constructing a play screen consisting of the extracted constituent portions; and
playing the constructed play screen.

28. (canceled)

29. The method of claim 26, wherein
the extracted constituent portions of the content are displayed to be discerned from the remaining constituent portions by adjusting at least one of resolution, color, size, and play speed of the extracted constituent portions.

30. A system for providing a user terminal with an information keyword related to content via a network, the system comprising:
a keyword management server to set and manage an information keyword that is output in association with content; and
an output processing server comprising a content identification unit to identify a portion providing the information keyword from an output content, a keyword allocation unit to allocate a corresponding information keyword to the identified portion, and a content output unit to add the allocated information keyword to the content and output the content,
wherein the output processing server outputs the portion corresponding to the information keyword to be discerned from a portion that does not correspond to the information keyword.

31. The system of claim 30, further comprising:
an advertisement search unit to search a list of currently maintained information keywords and contents related thereto according to a request of an advertiser and provide the result thereof;
an advertisement management server including an information host unit to compare a product/service list of the advertiser with information keywords and inform the advertiser when the information keyword mapping the product/service list is searched; and
an advertisement connection server to store and manage a corresponding information keyword in correspondence to advertisement content provided from the advertiser, according to an advertisement content connection request from the advertiser,
wherein when predetermined content and an information keyword related thereto are provided and the information keyword is selected, the advertisement connection server outputs advertisement content corresponding to the information keyword in interoperation with the output processing server.

32. The system of claim 31, further comprising:
an advertisement counter to count a number of outputs of the advertisement content and an output amount in association with the information keyword;
an advertisement cost calculator to calculate an advertisement cost based on the counted number of outputs of the advertisement content, the output amount, and an advertisement placement condition; and
a revenue distribution unit to determine a revenue distribution ratio with respect to an information keyword setter, a content creator, a content provider, and a keyword manager managing the information keyword that are related to the information keyword and distribute the calculated advertisement cost according to the determined distribution ratio.

33. The system of claim 30, wherein
the information keyword providing system provides an information keyword related to content that is provided via a content providing system providing the content for users via the network in interoperation with the content providing system.
